(19) United States
(12) Patent Application Publication
(10) Pub. No.: US 2017/0308741 A1
(43) Pub. Date: Oct. 26, 2017

(54) COMPUTERIZED SYSTEM AND METHOD FOR CONTINUOUSLY AUTHENTICATING A USERS IDENTITY DURING AN ONLINE SESSION AND PROVIDING ONLINE FUNCTIONALITY BASED THEREFROM

(71) Applicant: GLEIM CONFERENCING, LLC, Gainesville, FL (US)

(72) Inventors: Garrett William Gleim, Gainesville, FL (US); Samuel Rene Caldwell, Mulberry, FL (US)

(21) Appl. No.: 15/647,024

(22) Filed: Jul. 11, 2017

Related U.S. Application Data
(63) Continuation of application No. 14/586,355, filed on Dec. 30, 2014.
(60) Provisional application No. 61/923,333, filed on Jan. 3, 2014.
(60) Provisional application No. 61/987,073, filed on May 1, 2014.

(51) Int. Cl. G06K 9/00

(52) U.S. Cl. CPC G06K 9/00295; G06K 9/00899; G06K 9/00087; G06K 9/00288

(57) ABSTRACT

A method and system is disclosed for confirming the identity of students taking an exam online. A camera or similar device compares the image of a student to a known and verified Reference Image to confirm the identity of the student. Using data analysis on answers during the exam coupled with both the uniqueness of the browser used and the location of taking the online exam, provides information on whether the student may have been obtaining help from others. The result is identifying students who are cheating, colluding, or conspiring to falsify test scores.

### CROSS REFERENCE TO RELATED APPLICATIONS

This application is a continuation of U.S. patent application Ser. No. 14/586,355, filed Dec. 30, 2014, entitled SYSTEM AND METHOD FOR VALIDATING TEST TAKERS, which claims the benefit of priority of U.S. Provisional application Ser. No. 61/923,333, filed Jan. 3, 2014, entitled ANTI-CHEATING METHODS FOR VIRTUAL LEARNING SYSTEM, and U.S. Provisional application No. 61/987,073, filed May 1, 2014, entitled SYSTEM AND METHOD FOR VALIDATING TEST TAKERS, the contents of which are incorporated by reference herein in their entirety.

### BACKGROUND OF THE DISCLOSURE

Online educators currently have issues ascertaining whether the student taking an online test, quiz, or exam is really the student registered for the class. Teachers, professors, and academic institutions have solved this problem by requiring students to use an online proctoring company, such as ProctorU, where a 3^{rd} party proctor confirms the students' identities and then watches students while they take an online test, quiz, or exam to confirm the proper student is taking his or her own test, quiz or exam. Online proctoring companies require students to turn their video camera on so the proctor can watch them continuously during the test, quiz, or exam. This is a labor intensive method, not efficient, and can lend itself to bribery where the 3^{rd} party allows cheating to occur. Moreover, students often must pay, either directly or indirectly, for each occurrence of a human proctor monitoring their taking of an online test.

### SUMMARY OF THE DISCLOSURE

An embodiment of the present disclosure, hereinafter called “GleimCheck”, provides assurance that a student using an online learning system is who they are supposed to be. The system disclosed herein is a mechanism to help students reduce education related expenses. An initial verification confirms that a user is who they are supposed to be at the start of a test. An ongoing verification confirms that the same user continues to take the entire test. Another aspect of the present disclosure is a form of collaboration checking, called “GleimDetect”. GleimDetect is collaboration checking that confirms that the user taking the test is not collaborating with other test takers. Collaboration checking can occur during the test or exam or can be ascertained after the test. The ongoing verification can incorporate two or more image checks. A webcam captured image is compared to a Reference Image to initially confirm validation of a user, periodically captured again during the examination and verified, and bio-characteristics in the images are measured to confirm that it is a live person and not a photograph. Collaboration is checked by comparing the time, internet location, a physical location of the user to those of other users and browser uniqueness. This can happen while the exam is occurring or it can be determined afterwards using data obtained during the exam process.

An embodiment of a system for confirming test taker identity of a user taking a test during an online test in accordance with this disclosure may include a database containing at least one verified Reference Image of a user scheduled for taking a test, an imaging device such as a camera communicating with the database wherein the camera is operable to capture images of the user periodically during the taking of the test, and a software module connected to the database and to the camera operable to compare each of the captured images to the at least one Reference Image and determine whether the captured image matches the Reference Image. This exemplary system may further include an alarm module communicating with the software module operable to initiate an audible or visual alarm if one of the captured images does not match the at least one Reference Image during the taking of the test.

The visual alarm may be made visible to a user taking the test and/or may be provided to an administrator monitoring the taking of the test. In another embodiment the alarm can be an audio alarm provided to the user taking the test and/or may be provided to an administrator monitoring the taking of the test. The administrator's monitoring (visual and/or audio) can be done during the exam or performed after the exam. The image may be a photograph of the user taken from an official government identification document. The software module may be configured to confirm a match between one of the captured images and the verified Reference Image. If the match between the captured image and the at least one Reference Image is not made, then a second image may be captured and compared to the Reference Image to confirm that no match exists. If the second image also doesn't match the Reference Image then the alarm may be indicated and made available to either the administrator and/or the student in order to correct the condition. One skilled in the art will understand that the system could indicate an alarm on any number of predetermined events, such as 3, 5, or 11 incidents of the captured image not successfully comparing to the Reference Image.

The software module may further be operable to compare at least one biometric parameter obtained from the camera to a previous biometric parameter obtained from a prior captured image. For example, the at least one biometric parameter could be a user movement indicative of the user's pulse. Alternatively, the biometric parameter could also be a change of color of the user's face indicative of the user's pulse

An embodiment of the present disclosure may also be viewed as a method of confirming test taker identity of a user taking a test during administration of an online test. This method preferably includes operations of obtaining at least one verified Reference Image of a face of a user scheduled for taking a test and comparing the at least one verified Reference Image to a currently captured image of the face of the user via a camera attached to a computer to which the test is to be taken to confirm identity of the user.

If identity is confirmed, the method includes permitting the user to begin the test, capturing a plurality of images of the user during the taking of the test, comparing each of the plurality of captured images to the at least one Reference Image during the taking of the test, determining whether the captured image matches the Reference Image, and initiating a notification if one (or more) of the captured images does not match the at least one Reference Image during the taking of the test. The Reference Image preferably may be a photograph of the user taken from an official government identification document. If a match between the captured image and the at least one Reference Image is not made, then the method further includes capturing a second image and comparing the second image to the Reference Image to confirm that no match exists.

If the second image also doesn't match the Reference Image then the method may also include obtaining at least one biometric parameter from the camera and comparing it to a previous biometric parameter obtained from a prior captured image. Such a biometric parameter could be a user movement indicative of the user's pulse or a change in color of the user's face. Note that a method of comparing biometric parameters can be done after a determination is made that the first image doesn't match the Reference Image and not necessarily after a second instance of mismatch.

A method of confirming continued presence of a user such as a student taking an examination may include operations of obtaining at least one verified Reference Image of a face of the user, comparing the at least one verified Reference Image to a currently captured image of the face of the user via an imaging device attached to a computer to confirm identity of the user. If identity is confirmed, the imaging device continues to capture a plurality of images of the user over and during a predetermined period of time. Each of the plurality of captured images are compared to the Reference Image during the predetermined period of time to determine whether the captured image matches the Reference Image. A notification may then be initiated if one of the captured images does not match the at least one Reference Image during the predetermined period of time.

The method further may include determining whether the captured images are of a live user. This may be done by separating each of two or more sequentially captured images of the user into red, blue and green traces, and determining a fundamental frequency of one of the traces for the two or more sequentially captured images. This fundamental frequency will be a close approximation to the pulse rate of the user in the captured images, and hence determine that the user is, in fact, alive, and not simply a static image.

### DESCRIPTION OF THE DRAWINGS

FIG. 1 is flowchart of one embodiment of the process for GleimCheck Honesty Validation.

FIGS. 2A and 2B taken together is a flowchart of one embodiment of the process for GleimCheck Workflow of the GleimCheck Honesty Validation shown in FIG. 1.

FIG. 3 is a flowchart of one embodiment of the process for Face and Pulse Detection Software Architecture within the GleimCheck Workflow described in FIGS. 2A and 2B.

FIG. 4 is a flowchart of one embodiment of the process for a Collaboration Detection Workflow within the GleimCheck Honesty Validation shown in FIG. 1.

FIG. 5 is a representation of a client device utilized in an embodiment of the process of the present disclosure

FIG. 6 is a block diagram of a system utilizing an embodiment of the present disclosure.

FIG. 7 illustrates a face recognition module operation in accordance with an embodiment of the present disclosure.

FIG. 8 illustrates a pulse rate determination module operation in accordance with an embodiment of the present disclosure.

### DETAILED DESCRIPTION

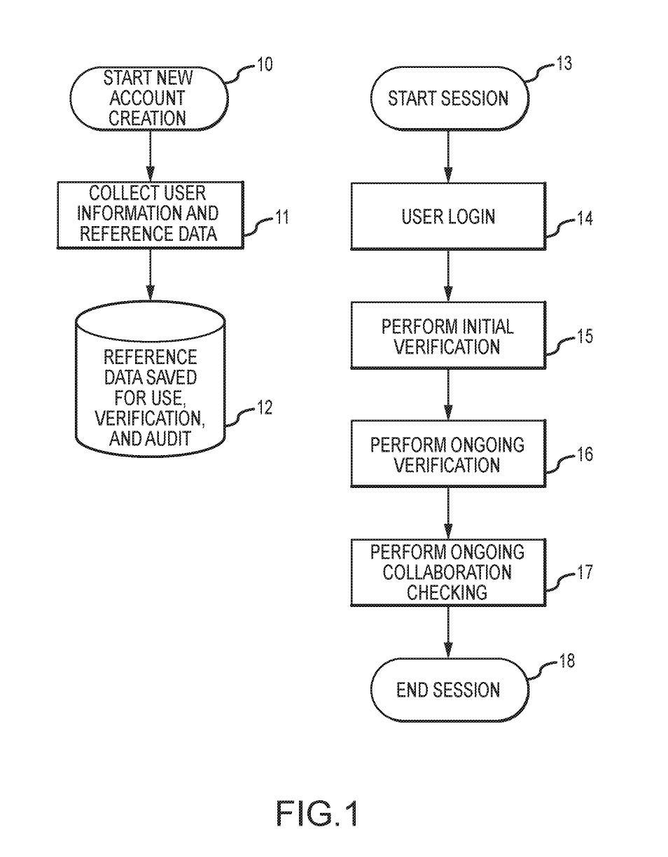

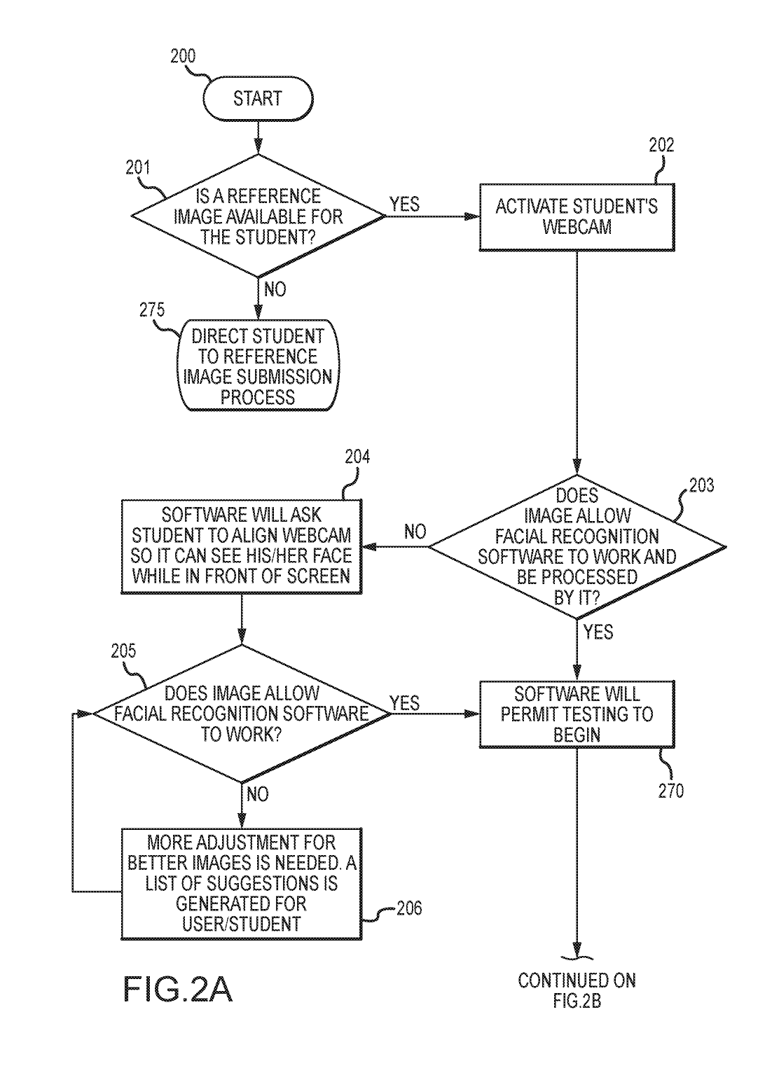

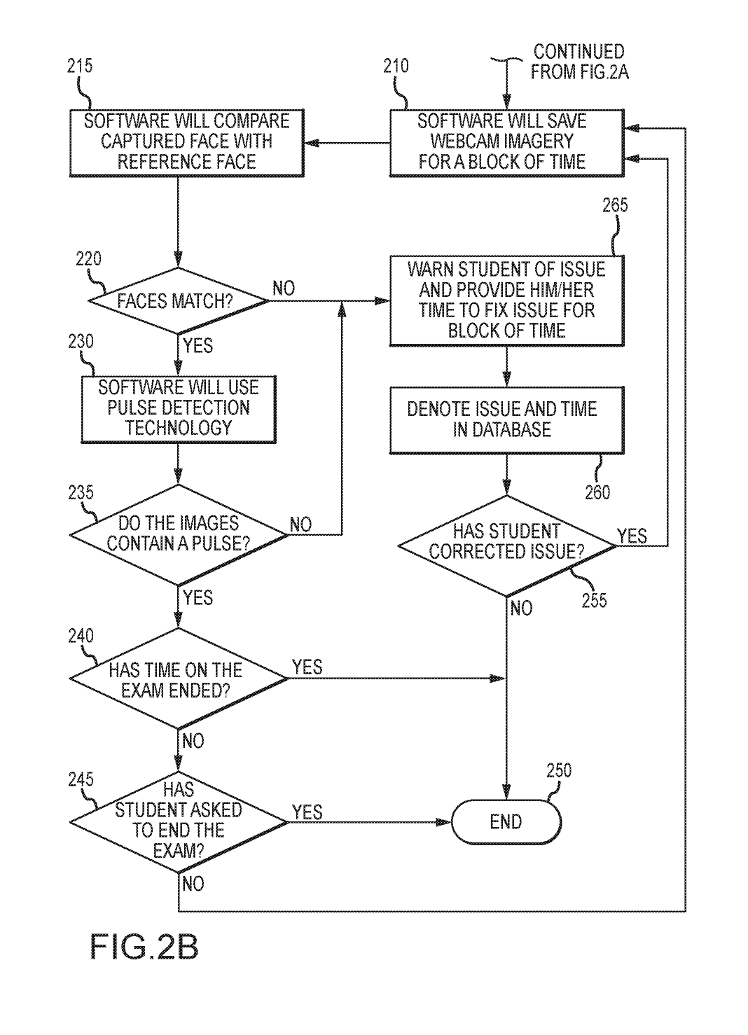

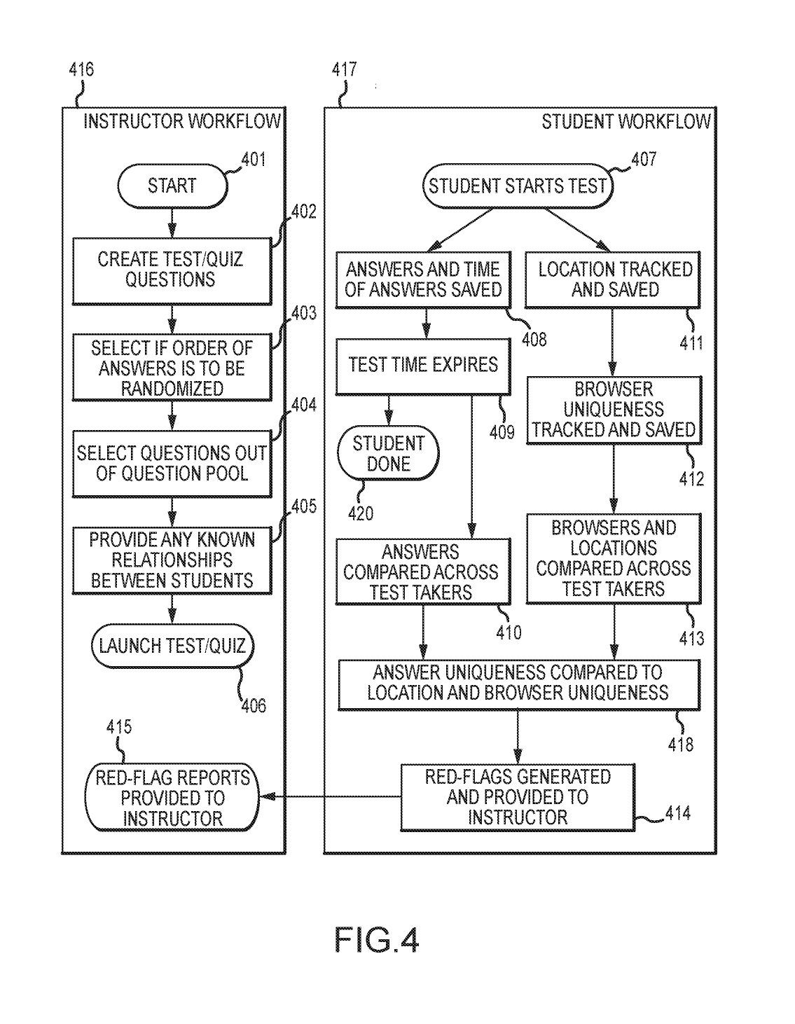

An exemplary embodiment in accordance with the present disclosure is called GleimCheck Honesty Validation (FIG. 1). GleimCheck Honesty Validation is composed of two component systems/methods that are designed to answer, collectively and/or independently, a question: In this student cheating? GleimCheck Honesty Validation does this by utilizing both the GleimCheck Workflow shown in FIGS. 2A and 2B and the Collaboration Detection Workflow as shown in FIG. 4. Each of these workflows can be operated independently or together within the GleimCheck Honesty Validation system/method. Throughout this disclosure, reference to GleimCheck indicates reference to the GleimCheck Workflow, which is depicted in FIGS. 2A and 2B. Throughout this disclosure, reference to GleimDetect indicates reference to the Collaboration Detection Workflow, which is depicted in FIG. 4.

An exemplary embodiment in accordance with the present disclosure is called GleimCheck. GleimCheck is a system and method designed to answer a question: Is the person at the computer who he/she says she is? Students participating in online courses typically use devices that incorporate a video camera or can add a camera in a straightforward manner, typically by purchasing an off-the-shelf USB connected webcam. In one embodiment, GleimCheck uses face recognition technology to compare the person in front of the camera to known identified photos. As used in this disclosure, known identified photos will be referred to as “Reference Image(s)”. GleimCheck can also use pulse detection technology to make sure that a picture has not been placed in front of the camera.

In another exemplary embodiment, GleimDetect verifies that each student is within a designated geographic area and identifies students that may be collaborating by comparing their location to the location of other students taking the same test. GleimDetect also compares the uniqueness of answers and incorrect answers. In addition, GleimDetect compares the uniqueness of each student's or user's web browser to ascertain whether students are using the same web browsers and, thereby, potentially cheating, colluding or conspiring together.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Throughout this disclosure, reference is made to a test, quiz, exam, examination, etc. It is to be understood that these are synonyms and can be used interchangeably. Furthermore, as used in this disclosure and the claims, the term “test” and “exam” also encompass any task that an on-line student is tasked to complete, such as homework assignments. Moreover, throughout this disclosure, it is to be understood that a student is a generic term for a user or participant taking a test. Finally, throughout this disclosure reference is made to a teacher, administrator, instructor, professor, etc. It is to be understood that these are synonyms and can be used interchangeably.

Throughout this disclosure, reference is made to administrators. It is to be understood that administrators can be any type of school employee or education consultant including, but not limited to, principal, dean, head teacher, tutor, academic advisor, academic director, proctor, faculty administrator, media technologist, psychometrician, teaching assistant, network administrator, behavior analyst, secretary, web content administrator, webmaster, etc.

Exemplary embodiments in accordance with the present disclosure involve a method/system of confirming students' or users' identity optionally in real time. One skilled in the art will know that this validation system could also be referred to as a honor system, honor method confirmation system, confirmation method, authentication system, authentication method, endorsement system, endorsement method, verification system, verification method, or characterized via many other similar phrases.

In one embodiment of the present disclosure, a picture of a student or user taking a test is taken with a webcam attached to the computer that the student is using to take the test and compared to a known Reference Image such as an image on a previously verified Student ID. Reference Images are either from government IDs, Student IDs, and/or approved images by an administrator or teacher where an administrator or teacher approves the Reference Image as accurately portraying the respective student. Potentially acceptable Reference Images include a Student ID card, a Driver's License, a Passport, an employer-issued identification card, or another government issue type of identification such as a military ID. Alternatively, a Reference Image might be an image/picture taken by the teacher or an administrator. The Reference Images are stored and become available to an administrator of the system, as well as the person who is required to authorize access and use of the system. A privacy statement and policy can safeguard this information.

In another embodiment of the present disclosure, a picture of a student or user taking a test is compared to a Secondary Image such as a Facebook or Flickr image. Secondary Images may be those that have been tagged by the individual or friends of the individual by way of a social network under the individual's control. For example, an individual may have several images in which they are tagged on Facebook, Google Plus, Flickr, LinkedIn, or another social network that can be associated with the individual's account by logging in through that network's API or by confirming that the user is in control of an email account tied to that address.

Using a Secondary Image as a means of identification may be secure enough for many applications. However, it is generally considered easier to create a falsified account (sometimes called a troll account) on a social network than it is to falsify a government-issued identification document. Thus, the existence of a social network account is considered a less authoritative validation source that the person operating the account is the person pictured in the account. For applications requiring additional security, Secondary Images can be validated by comparison to Reference Images and then used as Reference Images themselves. It may be advantageous to have more references images so that the system can be used to obtain more Reference Images by authenticating Secondary Images to add to the bank of Reference Images. In another embodiment, a teacher or administrator may approve Secondary Images as being bona-fide Secondary Images and/or approving Secondary Images as Reference Images.

In another embodiment in accordance with the present disclosure, a picture of a student or user taking a test is compared to a Crowd-sourced Image such as an image published to the other test takers to confirm their identities. Crowd-sourced Images may use an individual's existing social network to validate their identity. For example, students may be taking a class online but may still be required to participate in an exam at the same time or during a predetermined set of times. This means that classmates and the instructor are also online, allowing everyone to do a round-robin where each student has a snapshot or video stream from their webcam displayed to other students before the exam begins and each student is required to have a minimum number of confirmations for their identity to be validated. This process can proceed quickly, as each student can see a screen tiled with the images of other students. Each image could have, as an example, up to three options associated with the image, indicating, for example “I know them”, “I don't know them”, or “that's not them.” In another embodiment, a teacher or administrator may approve Crowd-sourced Images as being bona-fide Secondary Images, bona-fide Crowd-sourced Images and/or approving Crowd-sourced Images as Reference Images.

In one embodiment, a student may be considered validated after the video from their webcam can been viewed by a number of other students, such as three other students, and/or may require the administrator to personally validate them. This number three could be any number that provides the instructor with a satisfied feeling of knowing the classmates verified this particular student accurately. For example, a professor may wish to have x number of students or users confirm an identity or have greater than or less than x number of students or users confirm an identity; where x is variable equal to any positive integer (i.e., a positive whole number).

In one embodiment, the Crowd-sourced Images can be sorted with the least popular being assigned the most validation requests such that all students are validated in a similar period of time. Completely unknown students can have their images displayed to an instructor or proctor who can participate in the validation session.

In one embodiment, a Crowd-sourced Image or the process of confirming an identity using this Crowd-sourced Honesty Validation does not need to be limited to the group of students taking a common test. The process can be expanded such that anyone in the individual's social network can be used to perform validation, such as a colleague from a previous class, a previous teacher, or even a family member.

In an exemplary embodiment, the camera used can be a light-field camera, which is also known to one in the art as a plenoptic camera. A light-field camera often uses a microlens array to capture 4D light field information about a scene. They gather more light field information than traditional cameras and can be used to improve the solution of computer graphics and computer vision-related problems. In one embodiment, a benefit to light-field cameras is that images taken by them can be refocused after they are taken. In a further embodiment, the system or method can refocus the image many times to ascertain if there is more than one face in the frame, which may be out of focus and not ascertainable in the initial (or primary) picture image. Moreover, each time the image is refocused, the system or method can analyze the image against known devices, such as tablets, smartphones or augmented reality glasses, to ascertain whether these images are in the area of the student taking an exam.

One advantage of utilizing a light-field camera compared to a pinhole camera or other camera with the very large depth-of-field typical of small webcams, is that even when a webcam provides an image with a very large depth-of-field where the entire image is in focus, the webcam does not provide any information about the depths of the subject, regions of interest, or background of the image. A plenoptic camera can directly measure if it is capturing the flat image of a photograph placed in front of a camera or a curved subject that is set apart at a different distance than the background.

In one embodiment of this disclosure, instead of video or images, a 3D scanner could also be used. While cameras and microphones are built into each individual's computer, phone, or other electronic device, identity validation may also take advantage of 3D scanners. 3D scanners are devices similar to cameras that associate a depth with each area of the image, such that a three dimensional model of the object of interest can be generated. An object of interest is typically a human head. One skilled in the art will understand that 3D scanners can replace cameras or video cameras.

FIG. 1 shows a general embodiment of how this system/process begins. The process begins in process operation 10 in which a student or user creates an account. Control then transfers to operation 11. In process operation 11, the student or user submits Reference Images that will be used to confirm his or her identity. Optionally provision may be made for a professor or administrator to confirm or reject these submitted Reference Images. Control then transfers to operation 12. In process operation 12, the system stores this Reference Image for future reference and use in user sessions.

The process in FIG. 1 continues with the start or initiation of a new session. This is depicted as process operation 13 wherein the session begins. Control then transfers to operation 14. In process operation 14, the student or user logs into the system with a user name and password in a conventional manner known in the art. Control then transfers to operation 15. In process operation 15, the system performs an initial check to verify the user's identity. Control then transfers to operation 16. In process operation 16, the system performs ongoing, or periodic, verification that the authorized user is still operating the system, e.g. that the user has not logged in and then walked away and left someone else to continue the session. As an illustrative example, the system/method can confirm each student has a pulse and is not using a photograph to trick the system/method. Control then transfers to operation 17.

In process operation 17, the system performs ongoing collaboration checking to confirm, check or detect if the user is collaborating with another user. In one embodiment, these checks continue until the end of the session. Alternatively, these collaboration checks could be conducted after the student/user has completed the test. In such an alternative, batch processing could be done at one time after every student has taken the examination. Many online exams include provisions to provide the student with an option of taking the exam over a period of time, such as a few days, so students can choose the exact time they take their exam, such as a 2-3 hour exam. Control then transfers to session terminate operation, which is process operation 18.

An embodiment of the steps involved in the process operations of process operations 14, 15 and 16 just mentioned are explained in more detail in the flow diagram of FIGS. 2A and 2B. The GleimCheck software uses face recognition software to match the image in the camera to the known good images (i.e., Reference Images). FIGS. 2A and 2B together show the GleimCheck face recognition workflow.

In the process 200, a student begins GleimCheck by logging into the system. This log in may be accomplished by a user submitting a username and password or by an alternate session initiation method. This equates to Operation 14 in FIG. 1. Operations 201-206 in FIG. 2A correspond to operation 15 in FIG. 1. Operations 210-270 in FIG. 2B correspond to operation 16 in FIG. 1.

In an embodiment of process 200, an alternate session initiation method may be initiated by another session, which is already initiated. In particular, a student may already be logged into a Learning Management System operated by a school or educational services provider. Two examples of learning management systems (LMS) for online education available today are GleimU from Gleim Publications and “Blackboard” by Blackboard Inc. The educational services provider could use the existing session and user information to launch a GleimCheck Honesty Validation Session and/or a GleimCheck Session, typically by having the student follow a link to open a GleimCheck session in another window, another browser tab, as a new page, or as a new option in an existing browser tab or browser window.

In an embodiment of process 200, session initiation may also be performed by checking a biometric identity, such as a fingerprint. This process may use the same fingerprint or biometric reader as other services. However, while many fingerprint scanners provide authentication that is local to a device, GleimCheck may store the biometric identification data, such as a fingerprint, or metadata about the biometric identification in the cloud as an equivalent to a Reference Image that can be validated by comparison against a user's fingerprint. The result is that a fingerprint is a portable form of identification that a GleimCheck user can use to start a session anywhere and be validated by information stored on a server, the fingerprint check is not limited to use only on a specific device.

In process query 201, the system checks if a Reference Image is available for a student. If a Reference Image is available, then the system moves to process operation 202. If no Reference Image is available, then the system moves to process operation 275.

In process operation 275, the student is directed to create a Reference Image using the image submission process, which is depicted in FIG. 1 as process operation 11. Control then reverts back to query operation 201.

When the answer in query operation 201 becomes a yes, control transfers to operation 202. In process operation 202, the student's webcam or other image scanner is activated. Control then transfers to query operation 203.

In query process 203, the method queries whether the image allows the facial recognition software to work and be processed by it. For example, if no, this may mean that the lens has too many scratches, the lens needs to be cleaned, or that the individual is not properly in front of the camera. If yes, then method/process moves to process operation 270. If the image will not allow the facial recognition software to work, then the method/process moves to process operation 204.

In process operation 204, the software directs the student to align the webcam so that the software can correctly process the image. When an image is being used by a system and/or method, the verification system or method may need to encourage the user to align the camera so that the image can be processed by the verification method or system. A webcam image of the user's face is then taken. Control then transfers to query operation 205. Note that the webcam is being used as an example here for convenience. It is to be understood that any imaging device including, but not limited to, webcams, camera, 3D scanners, light-field camera, plenoptic camera, or video camera, could be substituted for a webcam when referenced above.

In query process 205, the system/method queries whether the acquired image will allow the facial recognition software to work and be processed by it. If yes, then control of method/process moves to process operation 270. If the image will not allow the facial recognition software to work, then control transfers to process operation 206.

In process operation 206, the system or method may ask for additional changes to make it easier for the software to process the image. Adjustments may include changes in lighting, camera sensitivity, refresh rate, or resolution, cleaning the camera lens, or even replacing the camera. These parameters may be specific to each session because of changes in internet bandwidth, lighting, processing power, physical location, or other conditions. The camera may also choose to display a smaller portion of the image to the user, such as a box in the center of the entire image capture area, while capturing a larger part of the image. One reason to do this is to detect the method of cheating in which the camera is positioned to place a collaborator or cheating device just outside of the displayed image. By displaying just a portion of the image, the camera may capture the collaborator or cheating device in the larger image. After the camera, depth sensing camera or other image capture device has been properly configured, the process returns to process query 205 until a satisfactory “yes” response in query operation 205 is generated, and control transfers through operation 270 to operation 210.

Operation 270 begins the test taking process for a particular user who has successfully logged in, created a suitable Reference Image or such a Reference Image has been identified and retrieved for use during the on-line testing session. Control then transfers to operation 210.

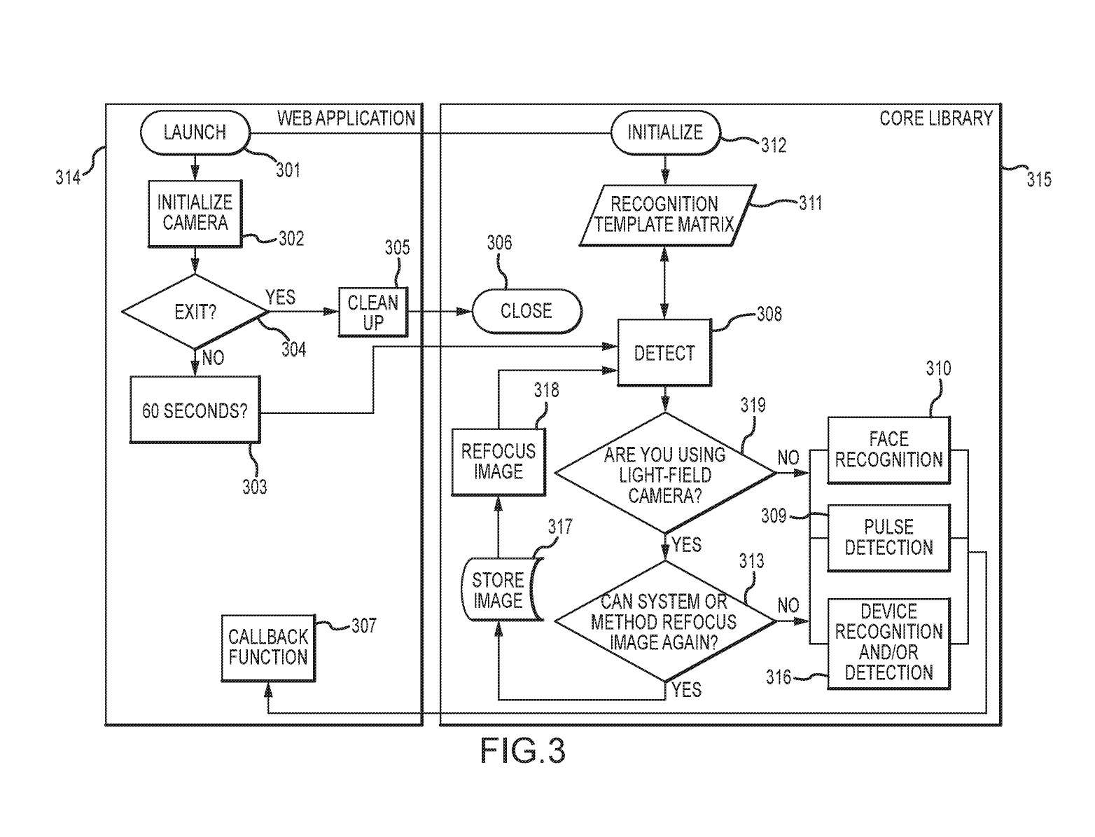

In process operation 210, images can be processed as video images in blocks of one or more video frames in a process described in more detail with reference to the architecture shown in FIG. 3. Control then transfers to process operation 215.

In process operation 215, the method/system then compares the face in the Reference Image to the face in the captured image to check if they match. This system may incorporate open source face recognition software. A likely source of open source software is OpenBR from openbiometrics.org. A potential alternative source of open source software is the landmark open-source implementation of facial landmark detector from The Center for Machine Perception at Czech Technical University in Prague. One skilled in the art understands that any number of facial recognition versions can be used including, but not limited to, other proprietary and non-open sourced methods of face recognition. Control transfers to query operation 220.

In query process operation 220, the system and/or method queries whether the face matching in process operation 215 is positive or negative. If the result of query is negative, then the process moves to process operation 265. If the result of the query is positive, then the process moves to process operation 230.

In process operation 265, the system and/or method warns the student of an identification verification issue having been sensed, or occurring. This issue could be, for example, that the faces do not still match after a minimum allowable mismatch time or that the image does not contain a pulse after a minimum allowable non-pulse time. This warning may occur over a period of time. One skilled in the art will understand that this notification could be in any numerous types of alerts including, but not limited to, a yellow light, red light state, or an audible sound. During this block of time of being in a state of warning, the student has time to correct the issue. During this block of time control transfers to process operation 260.

In process operation 260, this negative event of query process 220 is logged and the issue is stored in a database for later analysis. At the end of the block of time, control transfers to query operation 255.

In query operation 255, the software/method queries whether the student has corrected the issue. If the issue is not corrected, control transfers to operation 250 and the test is ended. If the issue has been corrected, the system/process moves back to process operation 210. Another embodiment could include a setting where the administrator wants a test to end immediately if it finds cheating. Therefore the process could go from query operation 220 directly to operation 250. Another embodiment could include a setting where from query operation 220, it may proceed to operation 260 and then operation 250 such that the system could log the cheating or abnormality for future reference. Another embodiment could include a setting where the process could go from process operation 260 to process operation 210. In this embodiment, the test does not end, but each negative occurrence is logged for future analysis by a teacher or administrator.

If, on the other hand, the faces match in query operation 220, control transfers to process operation 230. In process operation 230, the system/process checks that the image is that of a live person and not a photograph placed in front of the camera. In one embodiment, confirming that an image is an image of a person and not a photograph of a person can be as rudimentary as checking whether the image changes over a period of time in small ways, which would indicate movement and hence a live person image.

In another embodiment of process operation 230, the process/method uses pulse detection software to make sure that the image is that of a live person and not a photograph clipped in front of the camera. Pulse detection software is also known in the art. One of several available pulse detection methods is motion magnification/modulation from Massachusetts Institute of Technology (MIT). MIT's motion modulation methods are described in US Patent Publication Nos. 2014/0072190, 2014/0072228 and 2014/0072229. In the extraordinarily rare event of a student who does not have a pulse, such as some users of a continuous-flow left ventricular assist device, this check can simply be turned off. Therefore, in this embodiment, GleimCheck software does more than just check if the image changes at all, as a change can be the result of lighting changes or the camera shaking as someone types because GleimCheck can ascertain whether the student or user has a heartbeat. Control then transfers to query operation 235.

In process query 235, the system/method queries whether the image reflects a detectable pulse. If process query 235 is positive, a pulse is detected, then the process moves to query process 240. If process query 235 is negative, then the process moves to process operation 265, described above.

Note that queries 220 and 235 may be sequentially reversed, so operation 230 and query operation 235 could precede query 220.

In process query 240, the system/method queries whether the time on the exam has ended. If process query 240 is true, then the system/method proceeds to process end operation 250. If process query is false, then the system/method proceeds to process query 245.

In process query 245, the system/method queries whether the student has asked for the exam to end. If process query is true, then the system/method proceeds to end process operation 250. If process query is false, then the system/method proceeds to process operation 210. Note that operations 240 and 245 may be sequentially reversed.

FIG. 3 shows one embodiment of the face and pulse detection architecture. This architecture is divided into a web application 314 and a core library 315. Note that FIG. 3 references “camera” throughout and, as described above, “camera” is used for convenience, and could be any type of imaging device, as described above.

Web application 314 is generated with Adobe Flash, though those skilled in the art will know that web application 314 could also be implemented with another Rich Internet Application such as JavaFX or Microsoft Silverlight, as a stand-alone application, or potentially with a widely accepted browser-based interface such as HTML5.

In process operation 301, the web application 314 is launched. Control then transfers to operation 302.

In process operation 302, the web application initializes the camera (or other imaging device described above) and starts capturing images and video frames. Control then transfers through Exit query operation 304 to operation 303, assuming the answer in query operation 304 is No.

In process operation 303, the web application, for example, captures 3 seconds of video at 30 frames per second every 60 seconds and sends this information to the core library 315. In other words, in this example, 3 seconds of video out of every 60 seconds is captured and processed, so each second of captured video is allowed 20 seconds of processing time. This exemplary default duty cycle allows for a balance between power consumption, completeness of information, and consistent performance across older and newer hardware. One skilled in the art will realize that when three seconds of video can be processed in less than three seconds then the process can be run continuously. If a device is battery operated, running the device continuously may not be desired due to the power required. If a device is plugged into a wall, running the device continuously may not be desired if the device dissipates a significant amount of heat from continuous operation such as when a computer is placed on a user's lap. For a desktop device on wall power, continuous operation may provide the most convenience and optimal performance. Other duty cycles are possible. The three seconds out of 60 duty cycle can be easily adjusted manually or automatically.

In Exit query operation 304, the system/method checks if it is time to exit use of the camera. Such may be the case when allotted time period for the exam has expired or the student/user has asked to end the exam. In such a case, for example query process operation 304 equals yes, then control transfers, i.e., the system/method calls cleanup operation process operation 305.

In process operation 305, the system/method performs clean-up functions including shutting down the camera and signaling the core library to close by shifting control to process operation 306.

Web application 314 interacts with the user, sends information to core library 315, and receives information back from core library 315 via the callback function in operation process 307. It is core library 315 that performs image, test and location data comparison, and biometric processing.

Core library 315 is separated from web application 314 because it performs a different function. The core library 315 can be written in C and C++, which are very efficient at large amounts of processing, and then CrossBridge is used to cross-compile the code into Adobe AIR. It could also be compiled or cross-compiled in other platforms or Rich Internet Environments such as Microsoft SilverLight. Moreover, the core library could be written in many languages, including other languages that are efficient at computation and can be cross-compiled into a Low Level Virtual Machine (LLVM) language, including ActionScript, Ada, D, Fortran, OpenGL Shading Language, Haskell, Java bytecode, Julia, Objective-C, Python, Ruby, Rust, Scala and C#. The Core Library 315 interacts with the set of web applications through callback functions so that the web application and the core library can run on different platforms. In particular, the Core Library 315 can be run on the client, on the server, or the work can be divided between the client and the server based on what is most appropriate for each device.

In core library process operation 312, the core library is initialized by the process operation 301, which is the web application launch. Control then transfers to Matrix 311.

In Recognition Template Matrix 311, the system/method contains information about the Reference Images that may be retrieved from a server by the web application and provided as part of core library initialization. Control then transfers to library process operation 308.

In library process operation 308, the system/method finds the face in the image. In doing this, first in query operation 319, the system and or method queries whether the imaging device (e.g., camera) is a light-field camera. If yes, the process moves to query operation 313. If no, control transfers to process operations 310, 309 and 316.

In query operation 313, the system and/or method queries whether the system or method can refocus the image again. If yes, then the process moves to process operation 317 where the refocused image is stored for later use. If no, the process moves on to process operations 310, 309, and 316. One skilled in the art understands that there are nearly an infinite number of light-fields (i.e., images) that can be refocused, but in practice there will be a limited number of refocus-able light-fields (i.e., images). Given the equipment being used or the way the off-the-shelf light-field technology is being utilized, there will be a fixed number of possible refocusing events and therefore a fixed number of possible images. Query operation 313 may preferably ensure that the system or method uses the highest number of refocus events that is practical, which means there will be the highest amount of useful images available for detection.

After process operation 317, control moves to process operation 318. In process operation 318, the image to be refocused is refocused using light-field camera technology. Control then moves to operation 308 and the process repeats until no further refocusing can be done. Control then transfers to verification operations 310, 309, and 316.

The face may be further divided into regions of interest. The region of the image containing the face or other information from the image is then provided to face recognition process operation 310 for comparison. The region of the image containing the face, a region containing a portion of the face such as a cheek or forehead, or other information from the image is also sent to library process operation 309 for pulse detection. The result of these processes is then returned to web application 314 via callback function 307.

In process operation 316, the system checks for images of known computer devices within each picture or image captured. For example, the system would recognize what an iPad looks like from a Reference Image of an iPad in the cloud, and if it identifies an iPad in the image operation 316 would register the device. The cloud would need to be updated with known device shapes that could be used, such as Google glasses, iPads, iPhones, android tablets, etc. This is to check if students are cheating by using other devices such as an iPad to look up answers during the validation session.

Process operations 309 and 310 are only some of the checks of validity that can be performed by the core library 315. In other embodiments, other tests are possible if other input, sensory or biometric devices are available. Consumer electronics can contain other sensors and biometric devices. If these are present, GleimCheck may choose to support them as well. In particular, some consumer electronics devices support fingerprint readers. Fingerprint readers often compare a fingerprint to one stored locally on the device. GleimCheck could store fingerprint data in the cloud. This data could be collected out-of-band, such as during the initial generation of a student ID, or scanned during a validated session. To validate this fingerprint, GleimCheck may store a copy of the fingerprint on a server and then validate it against the copy scanned by the individual.

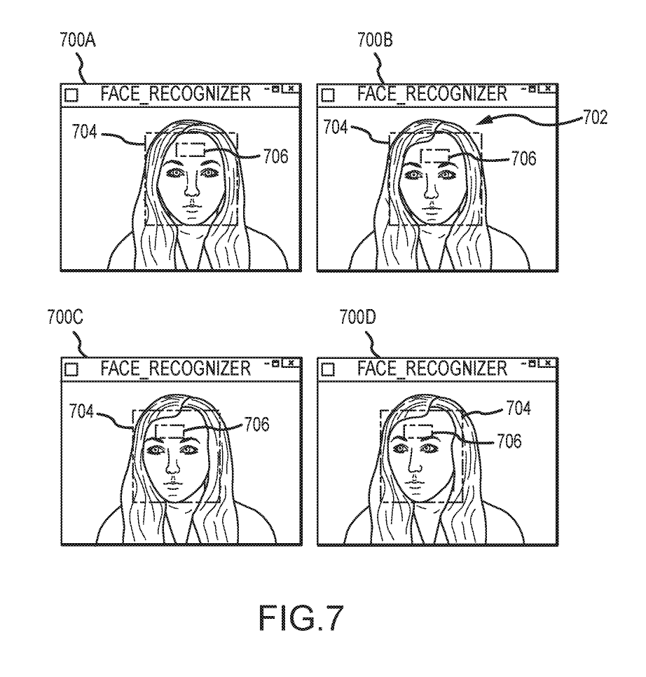

One example of a face recognition operational sequence in accordance one embodiment of the present disclosure is shown in FIG. 7. Four exemplary sequential video image frames 700A, 700B, 700C and 700D of a student facing the computer and its camera are shown. Face detection and eye detection are initial functions within face identification operation 310. The coordinates of a box 704 defining the face are determined from the image found in each frame. In addition, the algorithm examines pixel relationships within the frame and determines the x and y coordinates of the eyes, and the height and width that define the box 704 around the face. This box 704 includes the x and y coordinates for the left eye and right eye.

The box 704 is then further examined to determine a forehead portion 706 using a predefined percentage according to the detected location of the face and the eyes. This forehead portion 706 is then cropped out and passed to the pulse detection module 309 as a “region of interest”.

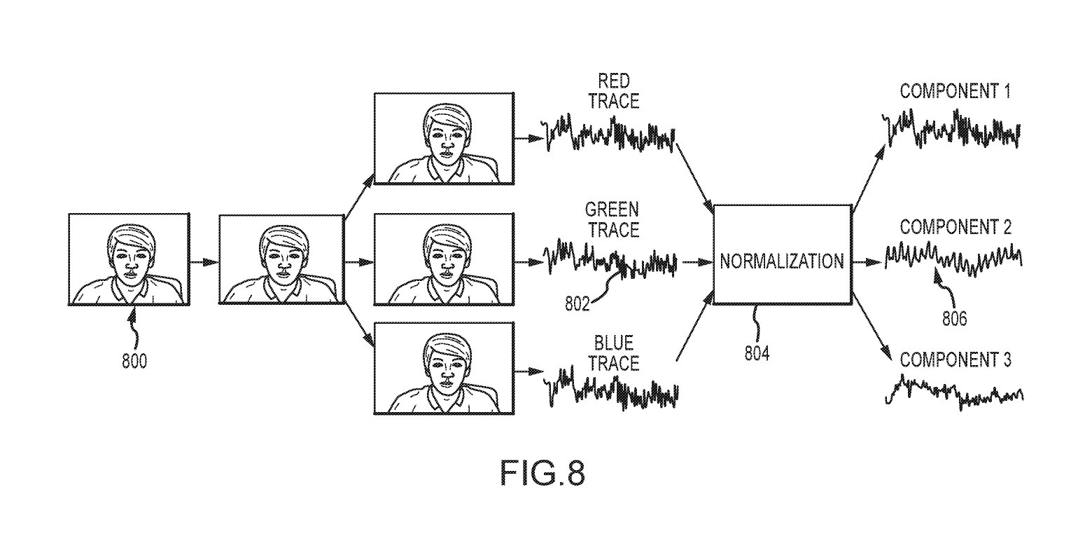

This portion 706 of the box 704 is then compared with the same region in adjacent sequential video frames. Each region of interest 706 is used to estimate a pulse rate of the user. The algorithm separates the region of interest identified in each frame into three RGB (Red, Green, Blue) channels of the region of interest in an image 800 of a student as is shown in FIG. 8. In this example, the green channel measurement is used. The green channel waveform 802 is combined with a temporal averaging operation and normalization 804 to form a target trace 806. The dominant, or fundamental, frequency is then easily determined from the target trace 806. This dominate frequency approximates the pulse rate of the individual shown in the video frame 800.

In another embodiment of this disclosure, a student may be issued or asked to purchase a device designed for the purpose of validating their identity. Such a device could be a web-camera with predetermined set of features, including a camera, infrared camera, microphone, 3D scanner, fingerprint reader, iris or other biometric scanner, or a radio frequency identification tag.

The method and system in accordance with the present disclosure combines authentication at the beginning of a test with authentication throughout the duration of a test. Thus, in addition to validating an individual's identity at the start of the session, their identity is validated continuously throughout the session. This assures that a photo of the user is not being used to trick the system while another person impersonates the validated user. Just checking if the image has changed is often not enough to solve this problem, as a change can indicate common conditions including, but not limited to, a change in lighting conditions and camera shake. Alternatively, rather than continual authentication during the test, images may be taken at predetermined intervals and stored for later analysis and verification once the test has been completed. This could be done in a batch process after everyone in the class has taken his or her exam, for example, because many online exams provide their students a multi-day timeframe to choose the exact time they take their exam (e.g., 2-3 hours).

The Graphical User Interface of GleimCheck can include a feedback pane or screen where a student or user can verify that they are verified. Verification can require some lighting (when using a visible light camera) and that the user's face is within view of the camera. Below the image of the user will be a display graphical user interface, such as a traffic light, that will help display the quality of the imagery being verified. One skilled in the art will understand that this graphical user interface need not be below a person, but could be anywhere on the screen. Moreover, one skilled in the art will understand that a visual graphical display need not be used, but an auditory alert could also be used, or both a graphical alert and auditory alert could be used in unison or concurrently. In an embodiment using a traffic light for a graphical user interface, a green light means that the user's identity is verified. A yellow light means that the user needs to adjust lighting or repoint the camera to get back to green light. A red light means that the user is not currently verified. One skilled in the art will understand that there are many types of graphical user interfaces that could be used and a traffic light is just one example.

In addition to validating the identity of each individual, GleimCheck Honesty Validation can check or ascertain if individuals are collaborating on assignments that are supposed to be completed individually. GleimDetect checks the correlation between users' locations, incorrect answers, and the time of those events to determine if individuals have been collaborating.

An embodiment of a process/method for collaboration detection in accordance with the present disclosure, referred to in operation 17 of FIG. 1, is shown in the flow diagram of FIG. 4. The process includes both instructor workflow 416 and student workflow processes 417. The instructor workflow process begins in operation 401 in which a professor, instructor, or administrator starts a workflow. Control then transfers to operation 402.

In process operation 402, the instructor or administrator creates a pool of test/quiz questions. Control then transfers to operation 403.

In process operation 403, the instructor or administrator selects if (s)he would like the order of the questions to be randomized. A randomized question order can make cheating more difficult but may also make the flow of the test more difficult. A non-randomized order makes cheating easier to perform and potentially easier to detect. Control then transfers to operation 404.

In process operation 404, the instructor, administrator or the computer can choose to test with a subset of all the questions from the test pool; one reason to do this may be to create tests with different question sets without the change in sequence caused by randomizing the question order. Process control then transfers to operation 405.

In process operation 405, the instructor or administrator provides any known relationship between students; for example, if multiple students are on the same sports team and are assigned the same tutor, it might be expected that their answers correlate differently than a random sampling of students. Process control then transfers to operation 406.

In process operation 406, the instructor or administrator launches the test, quiz, or exam and it becomes available to students, either immediately or during a scheduled set time or scheduled set of times.

In process operation 415, the instructor or administrator receives any red flags generated by the student(s) or user(s). These flags may be received either as they are generated or these red flags can be generated in a batch form and stored for review in one or more reports at a later time(s).

The student workflow 417 begins when a student starts the test in process operation 407. Control then triggers two (2) process operations to begin in parallel-process operation 408 and process operation 411.

In process operation 408, each of the student's or user's answers and the time of when each answer was made is saved until the test time expires in process operation 409 and/or the student is done in process operation 420. Optionally, this information can be saved and referenced at a later date or time.

In process operation 410, the answers and their answer times are then compared across test takers. This comparison is preferably a statistical analysis. One skilled in the art will understand that there are a wide variety of statistical analysis options in the public domain that could be utilized in process operation 410 including, but not limited to, scantron analysis, Monte Carlo Simulation, Belleza and Belleza's “Detection of Cheating on Multiple-choice Tests by Using Error-Similarity Analysis, or Scheck software based on Wesolowsky's “Detecting Excessive Similarity in Answers on Multiple Choice Exams.”

In process operation 411, the system/method tracks and saves the location of the student/user. One skilled in the art will understand that there are many location type of distinctions provided by browsers and software. For example, a web camera or video camera may provide a GPS location. Therefore, if a camera is being utilized during the test, such as when a professor or administrator requires Web Application 314 and Core Library 315, then the system/method may obtain GPS information on the student's or user's location.

In another embodiment of process operation 411, an Internet Protocol address provides location information that can be stored and used to gather information about a student(s) or user(s).

In another embodiment of process operation 411, a Wi-Fi router can provide information to the system/method. If multiple users are utilizing the same Wi-Fi router, it may provide information on whether a group or cluster of student(s) or user(s) are cheating, collaborating, or conspiring together. In an embodiment, the system/method may query the browser or application to provide Wi-Fi router information. Once the location or locations being tracked are saved, control transfers to operation 412.

In process operation 412, the uniqueness of the web browser being utilized by the student or user is tracked and saved. This information can be used at a later time, such as in process operation 413, to determine if other students or users utilized the same browser. Browser uniqueness can be defined as information a web browser provides or shares with any website the browser visits and this information can be unique. One skilled in the art knows that there are multiple software packages available to analyze and provide data on how unique each browser is. For example, one can use the Electronic Frontier Foundation's Panopticlick project (“How Unique Is Your Web Browser?” by Peter Eckersley). One skilled in the art understands that there are many browser uniqueness software packages available and many are held as proprietary trade secrets. One using this disclosure could use any one of these browser uniqueness methods. Once the browser uniqueness is saved, control transfers to operation 413.

In process operation 413, the browser and location are compared across test takers. In an embodiment, Internet Protocol address, Wi-Fi router information, and GPS information from a camera all provide location data for process operation 413. Control then transfers to operation 418.

In process operation 418, the answer uniqueness is compared to the location and browser uniqueness to determine which students are likely to be collaborating. This comparison check is preferably a statistical analysis. One skilled in the art will understand that there are a wide variety of statistical analysis options in the public domain that could be utilized in process operation 418 including, but not limited to, probability analysis and Monte Carlo Simulation. Probability analysis may include many of the same examples stated above. Control then transfers to operation 414.

In process operation 414, any red flags generated in process operation 418 are provided to the instructor and saved along with the supporting data, e.g. answers, times and locations for subsequent review and analysis if needed. Control is shifted to process operation 415.

The GleimCheck Honesty Validation software is initially available for Windows PC, Macs, and other devices capable of supporting a webcam and Adobe Flash Player. One skilled in the art will know that in addition to implementation on a Windows PC or Mac, GleimCheck Honesty Validation could be implemented as a mobile phone app, an app that does not require Adobe Flash Player, an app for a smartphone, tablet, Windows Phone, Android phone, iPhone, iPad, virtual reality or augmented reality headset, or other electronic device. One skilled in the art will also understand that HTML5 or Adobe AIR can also be used for GleimCheck Honesty Validation.

From this description, it will be appreciated that certain aspects are embodied in the user devices, certain aspects are embodied in the server systems, and certain aspects are embodied in a system as a whole. Embodiments disclosed can be implemented using hardware, programs of instruction, or combinations of hardware and programs of instructions.

In general, routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), or random access memory. In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

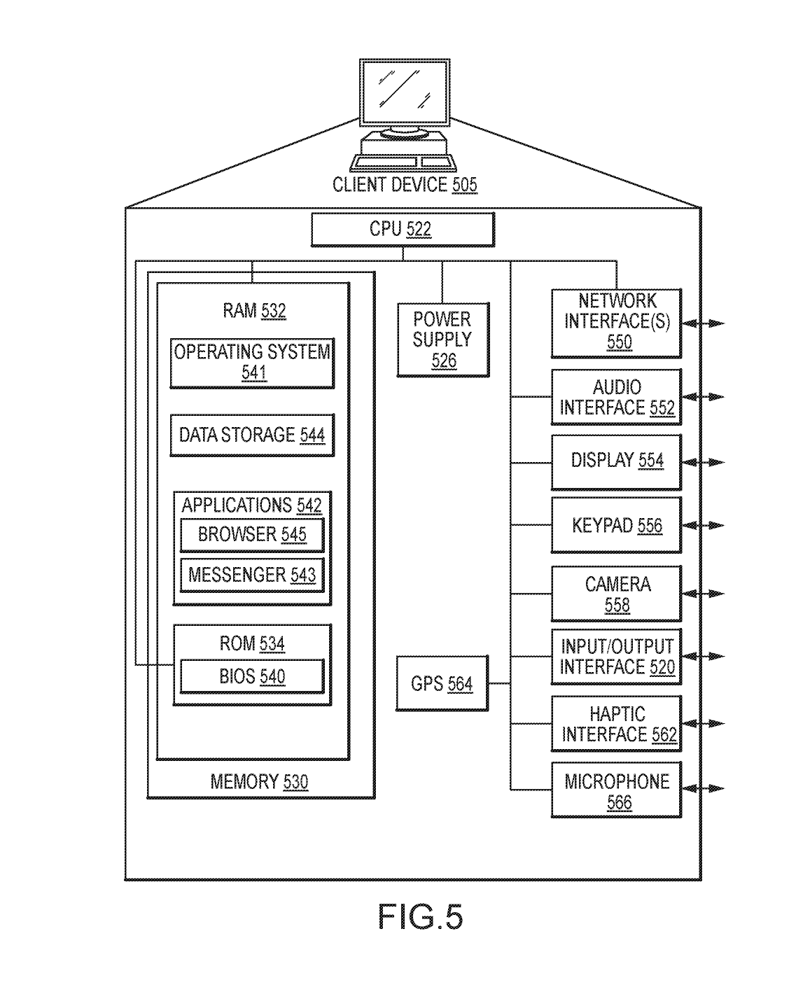

FIG. 5 shows one example of a schematic diagram illustrating a client device 505 upon which an exemplary embodiment of the present disclosure may be implemented. Client device 505 may include a computing device capable of sending or receiving signals, such as via a wired or wireless network. A client device 505 may, for example, include a desktop computer, a tablet computer, or a laptop computer, with a digital camera. The client device 505 may vary in terms of capabilities or features. Shown capabilities are merely exemplary.

As shown in the example of FIG. 5, client device 505 may include one or more processing units (also referred to herein as CPUs) 522, which interface with at least one computer bus. A memory 530 can be persistent storage and interfaces with the computer bus. The memory 530 includes RAM 532 and ROM 534. ROM 534 includes a BIOS 540. Memory 530 interfaces with the computer bus so as to provide information stored in memory 530 to CPU 522 during execution of software programs such as an operating system 541, application programs 542 such as device drivers (not shown), and software messenger module 543 and browser module 545, that comprise program code, and/or computer-executable process steps, incorporating functionality described herein, e.g., one or more of process flows described herein. CPU 522 first loads computer-executable process steps from storage, e.g., memory 532, data storage medium/media 544, removable media drive, and/or other storage device. CPU 522 can then execute the stored process steps in order to execute the loaded computer-executable process steps. Data storage medium/media 544 is a computer readable storage medium(s) that can be used to store software and data and one or more application programs. Persistent storage medium/media 544 can also be used to store device drivers, such as one or more of a digital camera driver, monitor driver, printer driver, scanner driver, or other device drivers, web pages, content files, playlists and other files. Client device 505 also preferably includes one or more of a power supply 526, network interface 550, audio interface 552, a display 554 (e.g., a monitor or screen), keypad 556, an imaging device such as a camera 558, I/O interface 520, a haptic interface 562, a GPS 564, and/or a microphone 566.

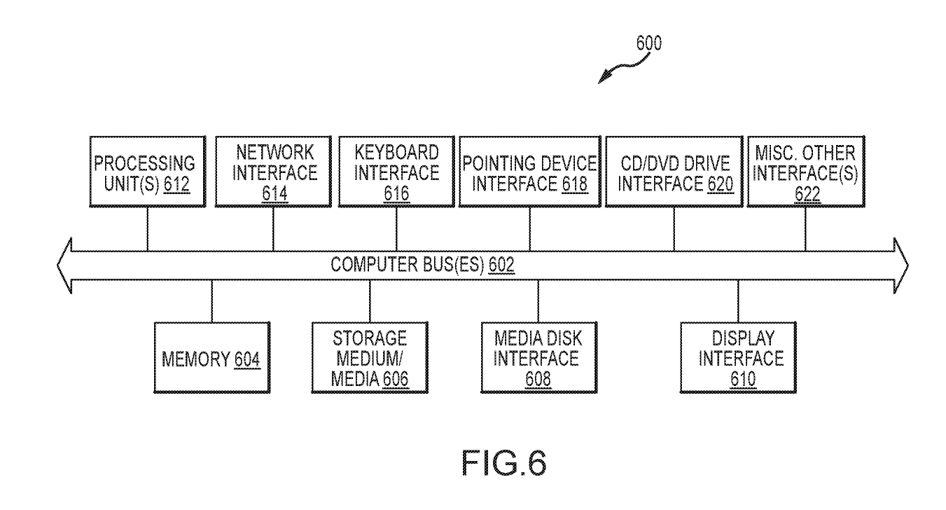

FIG. 6 is a block diagram illustrating an internal architecture 600 of an example of a computer, such as server computer and/or client device, utilized in accordance with one or more embodiments of the present disclosure. Internal architecture 600 includes one or more processing units (also referred to herein as CPUs) 612, which interface with at least one computer bus 602. Also interfacing with computer bus 602 are persistent storage medium/media 606, network interface 614, memory 604, e.g., random access memory (RAM), run-time transient memory, read only memory (ROM), etc., media disk drive interface 608 as an interface for a drive that can read and/or write to media including removable media such as floppy, CD-ROM, DVD, etc. media, display interface 610 as interface for a monitor or other display device, keyboard interface 616 as interface for a keyboard, pointing device interface 618 as an interface for a mouse or other pointing device, CD/DVD drive interface 620, and miscellaneous other interfaces 622, such as a camera interface, parallel and serial port interfaces, a universal serial bus (USB) interface, Apple's ThunderBolt and Firewire port interfaces, and the like.

Memory 604 interfaces with computer bus 602 so as to provide information stored in memory 604 to CPU 612 during execution of software programs such as an operating system, application programs, device drivers, and software modules that comprise program code, and/or computer-executable process steps, incorporating functionality described herein, e.g., one or more of process flows described herein. CPU 612 first loads computer-executable process steps from storage, e.g., memory 604, storage medium/media 606, removable media drive, and/or other storage device. CPU 612 can then execute the stored process steps in order to execute the loaded computer-executable process steps. Stored data, e.g., data stored by a storage device, can be accessed by CPU 612 during the execution of computer-executable process steps.

As described above, persistent storage medium/media 606 is a computer readable storage medium(s) that can be used to store software and data, e.g., an operating system and one or more application programs. Persistent storage medium/media 606 can also be used to store device drivers, such as one or more of a digital camera driver, monitor driver, printer driver, scanner driver, or other device drivers, web pages, content files, playlists and other files. Persistent storage medium/media 606 can further include program modules and data files used to implement one or more embodiments of the present disclosure.

Although the disclosure has been provided with reference to specific exemplary embodiments, it will be evident that the various modification and changes can be made to these embodiments without departing from the broader spirit as set forth in the claims. For example, while the above disclosure is directed toward a user taking an exam or test, the disclosed system and method may also be utilized for monitoring completion of homework assignments and other projects that can be administered and completed on-line. Furthermore, in many of the user interactions described above, the system and method queries can be implemented by an event driven system/method where an event notice is received and handled by an event handler. In such an instance, for example, instead of system/method querying a user if they have completed an exam, the user presses an “exit” or “I am done” icon/button, which sends the system an appropriate instruction or alert. Accordingly, the specification and drawings are to be regarded in an illustrative sense rather than in a restrictive sense.

All such changes, alternatives and equivalents in accordance with the features and benefits described herein, are within the scope of the present disclosure. Such changes and alternatives may be introduced without departing from the spirit and broad scope of my invention as defined by the claims below and their equivalents.

What is claimed is:

1. A method comprising:
receiving, at a computing device, a request from a user to access a computerized, online task, said task comprising an interactive online experience provided by the computing device over a network;
initiating, via the computing device, said online task based on said request, said initiating comprising causing data associated with the online task to be accessible to the user over the network, said initiating causing the online task to begin such that the interactive online experience runs for a predetermined period of time;
continuously capturing, via a camera associated with the computing device, a set of images during the duration of the online task, said continuous capturing comprising capturing each image within said set at predetermined intervals during said duration;
automatically analyzing, via the computing device, each image within said set as each image is captured, said analysis comprising identifying features of each captured image, and comparing, via the computing device executing facial recognition software on the image set, each image's captured image features with each other to determine a continuity between each image's features during said duration;
determining, via the computing device, based on said analysis, whether said user is falsifying an identify of the user at any point during said duration of the online task, wherein said falsified identify is based on the determination whether any of the features of an images in said set are different than other image's features in said set;
communicating, via the computing device, a notification indicating a result of said determination, wherein when said determination indicates that the user falsified said identify, said notification comprises an audible or visual alarm that is caused to be rendered on a device of the user, wherein when said determination indicates that the user did not falsify said identify, said notification enables the user to continue with said online task.

2. The method of claim 1, further comprising;
capturing, via the camera associated with the computing device, a second image of the user in response to receiving said request, said image depicting at least a face of the user.

3. The method of claim 2, further comprising:
identifying a reference image of the face of the user, said reference image being a previously obtained image stored in an associated database;
comparing, via the computing device, the captured second image and the reference image, said comparison comprising the computing device executing facial recognition software on the captured second image and the reference image, and determining, based on a result of said facial recognition software's execution, whether said captured second image matches the reference image; and
enabling the user to access said online task based on said determination.

4. The method of claim 3, wherein said reference image is an image selected from said database consisting of: a government ID, a profile picture from an online platform, a picture from a social media platform, a picture from a media hosting website, pictures hosted by websites on the Internet provided by the user, pictures hosted by websites on the Internet provided by friends of the user, tagged images on hosted platforms on the Internet and a crowd-sourced image.

5. The method of claim 2, wherein said analysis of a first captured image in said set captured at a first interval comprises comparing said first captured image to said second image, said comparison comprising the computing device executing facial recognition software on the first captured image and the second image, and determining, based on a result of said facial recognition software's execution, whether said first captured image matches the second image.

6. The method of claim 1, wherein said capturing of the set of images of the user is performed by the computing device implementing an associated 3D scanner, wherein said analysis of said captured images is based on 3D features generated from said 3D capturing.

7. The method of claim 1, further comprising:
storing, in a database associated with said computing device, each of the captured images in said set, wherein said analysis of each of the images in said set is performed upon completion of said online task.

8. The method of claim 1, wherein said predetermined intervals are intervals occurring between the initiation of the online task and completion of the duration of the online task.

9. The method of claim 1, wherein said online task is a test, wherein said test being said interactive online experience.

10. The method of claim 1, wherein when said determination indicates that the user falsified said identify, said notification is additionally sent to a device of an administrator alerting the administrator as to the falsified identity.

11. The method of claim 1, wherein said features of said captured images comprises data indicating lighting, camera sensitivity, resolution, physical conditions of the user's workspace, biometric parameters of the user, and time of the capturing.

12. A non-transitory computer-readable storage medium tangibly encoded with computer-executable instructions, that when executed by a processor associated with a computing device, performs a method comprising:
receiving, at the computing device, a request from a user to access a computerized, online task, said task comprising an interactive online experience provided by the computing device over a network;
initiating, via the computing device, said online task based on said request, said initiating comprising causing data associated with the online task to be accessible to the user over the network, said initiating causing the online task to begin such that the interactive online experience runs for a predetermined period of time;
continuously capturing, via a camera associated with the computing device, a set of images during the duration of the online task, said continuous capturing comprising capturing each image within said set at predetermined intervals during said duration;
automatically analyzing, via the computing device, each image within said set as each image is captured, said analysis comprising identifying features of each captured image, and comparing, via the computing device executing facial recognition software on the image set, each image's captured image features with each other to determine a continuity between each image's features during said duration;
determining, via the computing device, based on said analysis, whether said user is falsifying an identify of the user at any point during said duration of the online task, wherein said falsified identify is based on the determination whether any of the features of an images in said set are different than other image's features in said set;
communicating, via the computing device, a notification indicating a result of said determination, wherein when said determination indicates that the user falsified said identify, said notification comprises an audible or visual alarm that is caused to be rendered on a device of the user, wherein when said determination indicates that the user did not falsify said identify, said notification enables the user to continue with said online task.

13. The non-transitory computer-readable storage medium of claim 12, further comprising;
capturing, via the camera associated with the computing device, a second image of the user in response to receiving said request, said image depicting at least a face of the user.

14. The non-transitory computer-readable storage medium of claim 12, further comprising:
identifying a reference image of the face of the user, said reference image being a previously obtained image stored in an associated database;
comparing, via the computing device, the captured second image and the reference image, said comparison comprising the computing device executing facial recognition software on the captured second image and the reference image, and determining, based on a result of said facial recognition software's execution, whether said captured second image matches the reference image; and
enabling the user to access said online task based on said determination.

15. The non-transitory computer-readable storage medium of claim 12, wherein said analysis of a first captured image in said set captured at a first interval comprises comparing said first captured image to said second image, said comparison comprising the computing device executing facial recognition software on the first captured image and the second image, and determining, based on a result of said facial recognition software's execution, whether said first captured image matches the second image.

16. The non-transitory computer-readable storage medium of claim 12, wherein said capturing of the set of images of the user is performed by the computing device implementing an associated 3D scanner, wherein said analysis of said captured images is based on 3D features generated from said 3D capturing.

17. The non-transitory computer-readable storage medium of claim 12, further comprising:
storing, in a database associated with said computing device, each of the captured images in said set, wherein said analysis of each of the images in said set is performed upon completion of said online task, wherein said analysis is performed as a batch process for all users engaging in the online task.

18. The non-transitory computer-readable storage medium of claim 12, wherein when said determination indicates that the user falsified said identify, said notification is additionally sent to a device of an administrator alerting the administrator as to the falsified identity.

19. The non-transitory computer-readable storage medium of claim 12, wherein said features of said captured images comprises data indicating lighting, camera sensitivity, resolution, physical conditions of the user's workspace, biometric parameters of the user, and time of the capturing.

20. A computing device comprising:
a processor;
a non-transitory computer-readable storage medium for tangibly storing thereon program logic for execution by the processor, the program logic comprising:
logic executed by the processor for receiving, at a computing device, a request from a user to access a computerized, online task, said task comprising an interactive online experience provided by the computing device over a network;
logic executed by the processor for initiating, via the computing device, said online task based on said request, said initiating comprising causing data associated with the online task to be accessible to the user over the network, said initiating causing the online task to begin such that the interactive online experience runs for a predetermined period of time;
logic executed by the processor for continuously capturing, via a camera associated with the computing device, a set of images during the duration of the online task, said continuous capturing comprising capturing each image within said set at predetermined intervals during said duration;
logic executed by the processor for automatically analyzing, via the computing device, each image within said set as each image is captured, said analysis comprising identifying features of each captured image, and comparing, via the computing device executing facial recognition software on the image set, each image's captured image features with each other to determine a continuity between each image's features during said duration;
logic executed by the processor for determining, via the computing device, based on said analysis, whether said user is falsifying an identify of the user at any point during said duration of the online task, wherein said falsified identify is based on the determination whether any of the features of an images in said set are different than other image's features in said set;
logic executed by the processor for communicating, via the computing device, a notification indicating a result of said determination, wherein when said determination indicates that the user falsified said identify, said notification comprises an audible or visual alarm that is caused to be rendered on a device of the user, wherein when said determination indicates that the user did not falsify said identify, said notification enables the user to continue with said online task.
